(19) United States
(12) Patent Application Publication
(10) Pub. No.: US 2025/0187521 A1
(43) Pub. Date: Jun. 12, 2025

(54) RAMP MODULE OF VEHICLE

(71) Applicants: Hyundai Motor Company, Seoul (KR); Kia Corporation, Seoul (KR)

(72) Inventors: Jiae Yong, Hwaseong-si (KR); Jejoon Lee, Hwaseong-si (KR); Chulhee Heo, Hwaseong-si (KR); Dong Kyu Kim, Hwaseong-si (KR)

(21) Appl. No.: 18/813,716

(22) Filed: Aug. 23, 2024

(30) Foreign Application Priority Data
Dec. 8, 2023 (KR) 10-2023-0177520

(51) Int. Cl. B60P 1/43; A61G 3/06; A61G 3/08; B62D 25/20

(52) U.S. Cl. CPC B60P 1/433; A61G 3/061; B62D 25/2036; A61G 3/0808

(57) ABSTRACT

An embodiment ramp module of a vehicle disposed on a vehicle body inside the vehicle includes a center floor front member and a center floor rear member disposed at a center portion of a lower portion of the vehicle body in a transverse direction of the vehicle body, a center floor side member disposed in a longitudinal direction of the vehicle body and connecting the center floor front member and the center floor rear member at one side of the vehicle body, and a center in-floor ramp module covering the center floor front member, the center floor rear member, and the center floor side member, the center in-floor ramp module being slidably movable in the transverse direction of the vehicle body.

### CROSS-REFERENCE TO RELATED APPLICATIONS

This application claims the benefit of Korean Patent Application No. 10-2023-0177520, filed on Dec. 8, 2023, which application is hereby incorporated herein by reference.

### TECHNICAL FIELD

The present disclosure relates to a ramp module of a vehicle.

### BACKGROUND

In general, auxiliary getting on/off footboards (ramp systems) are installed on and used in vehicles in which people with mobility impairments ride. Ramp systems are mainly used in an under-floor insertion method in which ramp systems protrude from a vehicle when necessary while being inserted into an under-floor of the vehicle or in a separate type method using a separate device accommodated in a trunk space of the vehicle.

In the case of a vehicle where a user uses a wheelchair, as shown in FIG. 1, the entire vehicle body of the trunk side of a vehicle 1 is cut to secure a space into which the wheelchair, etc. may enter, and a separate ramp device accommodated in the trunk space is used. The wheelchair may enter or exit the vehicle by connecting a ramp device 4 to a floor 3 inside the vehicle through the cut vehicle body of the trunk side and opening a trunk side door 2.

In the case of such a separate type method, it is difficult to secure a space for accommodating a ramp device when the ramp device is not used, and it is difficult to store and use the ramp device because the user needs to install the ramp device personally due to a high weight whenever the ramp device is used. In addition, most of these vehicle models are manufactured by special companies and manufactured at high prices, and thus, the customer base is limited.

### SUMMARY

The present disclosure relates to a ramp module of a vehicle. Particular embodiments relate to an in-floor ramp module of a vehicle that includes a flattening panel mounted on a lower radial vehicle body member and slides.

Embodiments of the present disclosure provide an in-floor ramp module capable of the maximum common use by using a lower radial vehicle body member of the existing vehicle without changing a vehicle model and capable of convenient use of a user by installing a panel for flattening and employing a ramp device that slides through a side door of the vehicle.

A ramp module of a vehicle installed on a vehicle body inside the vehicle according to an embodiment of the present disclosure includes a center floor front member and a center floor rear member disposed at a center portion of a lower portion of the vehicle body in a transverse direction of the vehicle body, a center floor side member configured to connect the center floor front member and the center floor rear member at one side of the vehicle body and disposed in a longitudinal direction, and a center in-floor ramp module installed to cover the center floor front member, the center floor rear member, and the center floor side member and slidably moved in the transverse direction of the vehicle body.

The ramp module of the vehicle may further include a rear floor front member disposed in a rear portion of the lower portion of the vehicle body in the transverse direction of the vehicle body.

A lower part of the center floor side member may be connected to a side seal of the vehicle body with the vehicle body therebetween.

In the center floor front member and the rear floor front member, an anchor mounting member configured to fix a ride inside the vehicle may be provided.

The center in-floor ramp module may include a plurality of ramp module members fixed to the center floor front member, the center floor rear member, and the center floor side member and a ramp installed to slidably move in the transverse direction of the vehicle body between the ramp module members.

The plurality of ramp module members may include a front ramp module member and a rear ramp module member disposed in the transverse direction of the vehicle body, and a center ramp module member configured to connect center parts of the front ramp module member and the rear ramp module member and disposed in a longitudinal direction of the vehicle body.

The front ramp module member and the rear ramp module member may partially overlap on and be bolt coupled onto the center floor front member and the center floor rear member.

The ramp may be disposed to be slidable between a floor part formed by a space between the front ramp module member and the rear ramp module member and a lower portion of the center ramp module member.

The ramp module of the vehicle according to an embodiment of the present disclosure may further include a center flattening panel covering the ramp module member, the ramp, and the center floor side member, a front flattening panel covering the center floor front member, and a rear flattening panel covering the rear floor front member.

The center flattening panel, the front flattening panel, and the rear flattening panel may be made of aluminum (Al) plates.

The front flattening panel may be fixed to a rear surface of a first row seat member of the vehicle body and to the center floor front member by a bolt.

The rear flattening panel may be fixed to a front surface and a wheel side of a third row seat member of the vehicle body and to the rear floor front member by bolts.

On an end of the ramp on the opposite side of the center floor side member, a ramp reinforcement member used to withdraw the ramp to the outside of the center in-floor ramp module and support the ramp on the ground after withdrawing may be further provided.

A groove extending in a longitudinal direction of the ramp reinforcement member may be formed in the ramp reinforcement member.

In a center part of the center floor side member, a dummy reinforcement center floor side member extending in the transverse direction of the vehicle body may be further provided.

In the ramp, a ramp slit opening into which the dummy reinforcement center floor side member is inserted and mounted may be further provided.

On an outer circumference of the ramp slit opening, a step portion protruding upward from the ramp may be formed.

According to an embodiment of the present disclosure, by employing a structure in which the in-floor ramp module for people with mobility impairments to get on the vehicle is mounted to the lower radial vehicle body member, it is possible to respond to a purpose based vehicle (PBV) market of various specifications by maximizing common use without changing the existing vehicle model.

In addition, by installing the flattening panel and employing the ramp device that is accommodated in a lower portion thereof and slides through the side door of the vehicle, the appearance may be beautiful and loading and usability may be improved.

### BRIEF DESCRIPTION OF THE DRAWINGS

FIG. 1 is a diagram showing the use state of an existing in-floor ramp module.

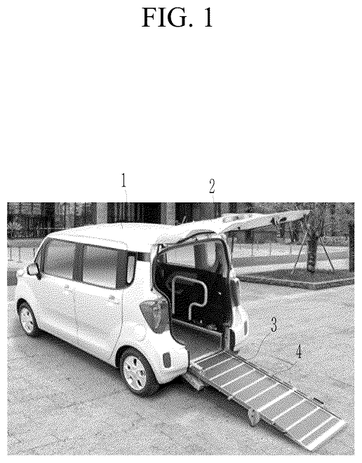

FIG. 2 is a diagram showing a lower radial vehicle body member of a vehicle installed on a vehicle body according to an embodiment of the present disclosure.

FIG. 3 is a cross-sectional view taken along line ‘A-A’ of FIG. 2.

FIG. 4 is a cross-sectional view taken along line ‘B-B’ of FIG. 2.

FIG. 5 is a diagram showing anchor mounting members fixing a wheelchair installed on the lower radial vehicle body member of the vehicle according to an embodiment of the present disclosure.

FIG. 6 is a diagram showing a center in-floor ramp module installed on the lower radial vehicle body member of the vehicle according to an embodiment of the present disclosure.

FIG. 7 is a cross-sectional view taken along line ‘C-C’ of FIG. 6.

FIG. 8 is a diagram showing a center flattening panel installed on a ramp module member of the vehicle according to an embodiment of the present disclosure.

FIG. 9 is a cross-sectional view taken along line ‘D-D’ of FIG. 8.

FIG. 10 is a diagram showing the center flattening panel and a front flattening panel installed on the ramp module member of the vehicle according to an embodiment of the present disclosure.

FIG. 11 is an enlarged view showing the fixing state of the front flattening panel of FIG. 10.

FIG. 12 is a diagram showing the center flattening panel, the front flattening panel, and a rear flattening panel installed on the ramp module member of the vehicle according to an embodiment of the present disclosure.

FIG. 13 is an enlarged view showing the fixing state of the rear flattening panel of FIG. 12.

FIG. 14 is a diagram showing the use state of a ramp of the ramp module member of the vehicle according to an embodiment of the present disclosure.

FIG. 15 is a diagram showing a dummy reinforcement center floor side member further provided on the lower radial vehicle body member of the vehicle according to an embodiment of the present disclosure.

FIG. 16 is a diagram showing a ramp reinforcement member, a ramp slit opening, and a step portion further provided on the ramp of the ramp module of the vehicle according to an embodiment of the present disclosure.

FIG. 17 is a diagram showing the use state of the ramp of FIG. 16.

FIG. 18 is an enlarged view of the ramp of FIG. 16.

### DETAILED DESCRIPTION OF ILLUSTRATIVE EMBODIMENTS

Embodiments of the present disclosure will be described more fully hereinafter with reference to the accompanying drawings, so that those skilled in the art to which the present disclosure pertains may easily implement the embodiments of the present disclosure. However, the present disclosure may be implemented in many different forms and is not limited to the embodiments described herein.

In addition, in various embodiments, elements having the same configuration are typically described in the embodiments by using the same reference numerals, and in other embodiments, only configurations different from the initial embodiment will be described.

Please note that the drawings are schematic and not drawn to scale. Relative dimensions and ratios of parts in the drawings are shown exaggerated or reduced in size for clarity and convenience in the drawings, and any dimensions are illustrative only and not limiting. In addition, the same reference numerals are used to denote similar features in the same structure, element, or parts appearing in two or more drawings. When an element is referred to as being “on” another element, it may be directly on the other element or intervening elements may also be accompanied.

The embodiments of the present disclosure specifically represent exemplary embodiments of the present disclosure. As a result, various modifications of diagrams are expected. Therefore, the embodiments are not limited to a specific shape of an area shown, and include, for example, a modification of the shape by manufacturing.

Hereinafter, a ramp module of a vehicle according to embodiments of the present disclosure will be described in detail with reference to the drawings.

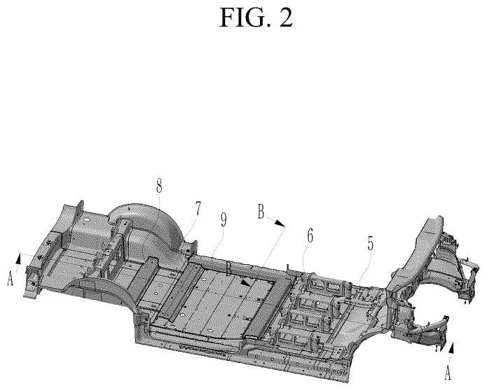

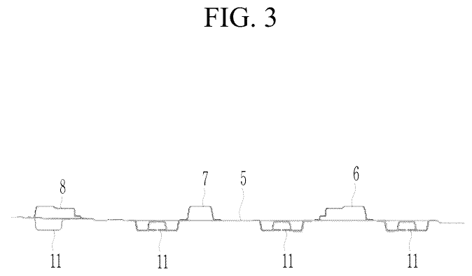

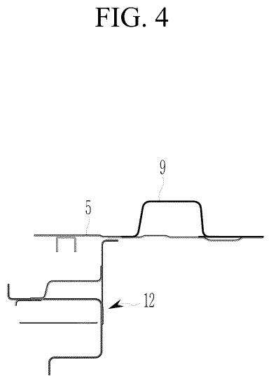

FIG. 2 is a diagram showing a lower radial vehicle body member of a vehicle installed on a vehicle body according to an embodiment of the present disclosure. FIG. 3 is a cross-sectional view taken along line ‘A-A’ of FIG. 2. FIG. 4 is a cross-sectional view taken along line ‘B-B’ of FIG. 2.

Referring to FIG. 2, a ramp module of a vehicle according to an embodiment of the present disclosure includes lower radial vehicle body members 6, 7, 8, and 9. The lower radial vehicle body members 6, 7, 8, and 9 include the plurality of center portion members 6, 7, and 9 disposed in a center portion of a lower portion of a vehicle body 5 and a rear portion member 8 (rear floor front member) disposed in a rear portion of the lower portion of the vehicle body 5.

The plurality of center portion members 6, 7, and 9 may be disposed in transverse and longitudinal directions of the vehicle body 5, respectively. FIG. 2 shows an example in which the two center portion members 6 and 7 are disposed in the transverse direction and the one center portion member 9 is disposed in the longitudinal direction, and the numbers thereof are not limited thereto.

The center portion members 6, 7, and 9 may include the center floor front member 6 disposed in the transverse direction at the front of the vehicle body 5 and the center floor rear member 7 disposed in the transverse direction at the rear of the vehicle body 5. In addition, the center members 6, 7, and 9 may include the center floor side member 9 connecting the center floor front member 6 and the center floor rear member 7 on one side of the vehicle body 5 and disposed in the longitudinal direction of the vehicle body 5.

The rear floor front member 8 may be disposed in the transverse direction at the rear of the center floor rear member 7 at the rear of the vehicle body 5.

As shown in FIG. 3, the center floor front member 6, the center floor rear member 7, and the rear floor front member 8 may be configured as annular members in a shape with a lower portion welded to an upper surface of the vehicle body 5 and a protruding upper portion.

A plurality of battery mounting members 11 may be welded to a lower surface of the vehicle body 5 in the transverse direction of the vehicle body 5, thereby contributing to improving the durability crash performance of the vehicle body 5 together with the lower radial vehicle body members 6, 7, 8, and 9.

As shown in FIG. 4, the center floor side member 9 may be configured as an annular member in a shape with a lower portion welded to the upper surface of the vehicle body 5 and a protruding upper portion.

In addition, a lower part of the center floor side member 9 may be connected by a side sill 12 coupled to the lower surface of the vehicle body 5 with the vehicle body 5 therebetween, i.e., by the vehicle body 5, thereby improving the rigidity of the vehicle body 5.

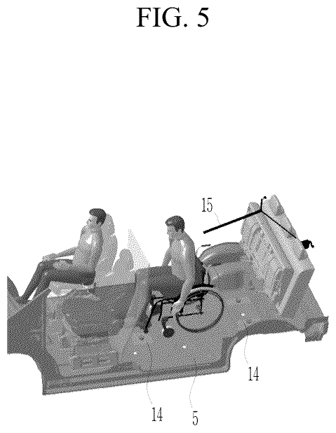

FIG. 5 is a diagram showing anchor mounting members fixing a wheelchair installed on a lower radial vehicle body member of a vehicle according to an embodiment of the present disclosure.

As shown in FIG. 5, the center floor front member 6 and the rear floor front member 8 may include anchor mounting members 14 fixing a ride (for example, a wheelchair) used by a passenger riding inside the vehicle. The anchor mounting members 14 may be provided in plural at predetermined intervals at the front and rear of the ride.

In addition, a ride fixing device 15, such as a detachable belt fixing the ride, may be provided in a rear seat inside the vehicle body 5.

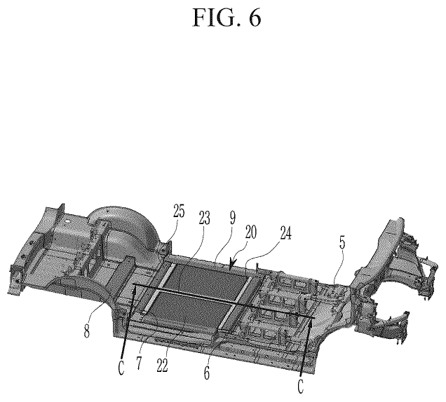

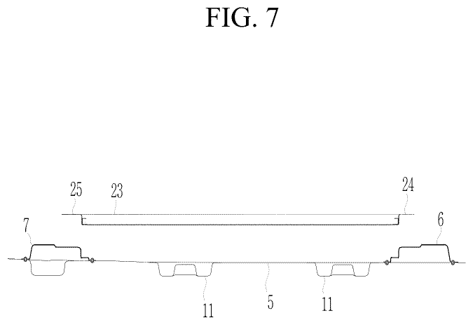

FIG. 6 is a diagram showing a center in-floor ramp module installed on a lower radial vehicle body member of a vehicle according to an embodiment of the present disclosure. FIG. 7 is a cross-sectional view taken along line ‘C-C’ of FIG. 6.

Referring to FIG. 6, the ramp module of the vehicle according to an embodiment of the present disclosure may include a center in-floor ramp module 20 that is installed to cover the center floor front member 6, the center floor rear member 7, and the center floor side member 9 and is slidably moved in the transverse direction of the vehicle body 5.

The center in-floor ramp module 20 includes a plurality of ramp module members 23, 24, and 25 that are fixed to the center floor front member 6, the center floor rear member 7, and the center floor side member 9 and a ramp 22 that is installed to be slidably moved in the transverse direction of the vehicle body 5 between the ramp module members 23, 24, and 25.

The ramp module members 23, 24, and 25 may include the front ramp module member 24 and the rear ramp module member 25 that are disposed in the transverse direction of the vehicle body 5 and the center ramp module member 23 that connects center parts of the front ramp module member 24 and the rear ramp module member 25 and is disposed in the longitudinal direction of the vehicle body 5.

The ramp 22 may be installed to be slidably moved in the transverse direction of the vehicle body 5 between the ramp module members 23, 24, and 25 and be withdrawn outward from the vehicle body 5 or accommodated in the vehicle body 5 through a door of the vehicle body 5.

As shown in FIG. 7, the front ramp module member 24 and the rear ramp module member 25 may partially overlap on and be bolt coupled onto the center floor front member 6 and the center floor rear member 7.

In addition, a floor part space which is retreated toward a lower portion of the vehicle body 5 is formed between the front ramp module member 24 and the rear ramp module member 25, and the ramp 22 is disposed to be slidable in the floor part space. The ramp 22 may be located between a lower portion of the center ramp module member 23 and the floor part space and stably disposed without being separated.

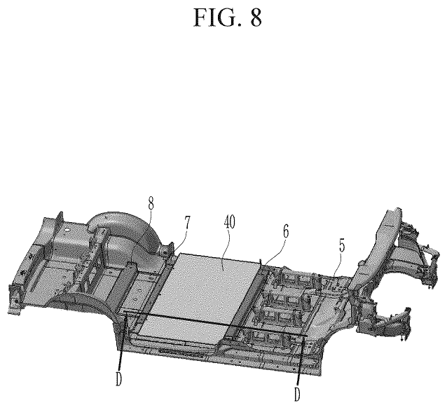

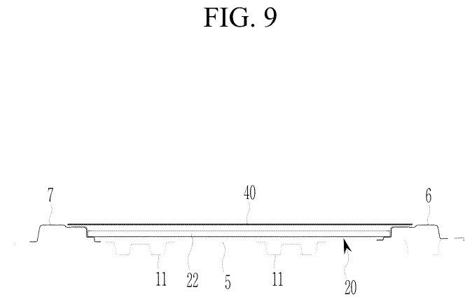

FIG. 8 is a diagram showing a center flattening panel installed on a ramp module member of a vehicle according to an embodiment of the present disclosure. FIG. 9 is a cross-sectional view taken along line ‘D-D’ of FIG. 8.

Referring to FIG. 8, the ramp module of the vehicle according to an embodiment of the present disclosure may further include a center flattening panel 40 covering the ramp module members 23, 24, and 25, the ramp 22, and the center floor side member 9.

As shown in FIG. 9, the center flattening panel 40 may be mounted with front and rear edge parts coupled by bolts onto the center floor front member 6 and the center floor rear member 7.

The center flattening panel 40 is a part that a passenger directly touches and supports and may be made of an aluminum (Al) plate.

The ramp 22 may be disposed to be slidably movable at a lower portion of the center flattening panel 40, and while the ramp 22 is withdrawn to the outside of the center flattening panel 40, the height of an upper surface of the ramp 22 may be adjusted to match the height of an upper surface of the center flattening panel 40.

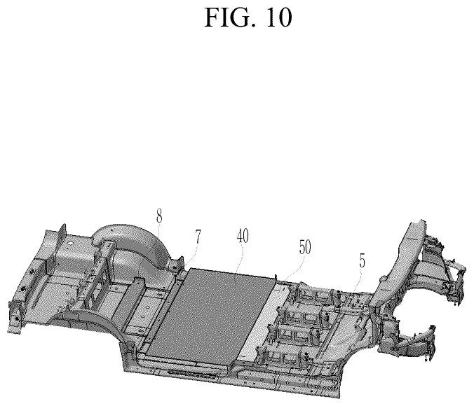

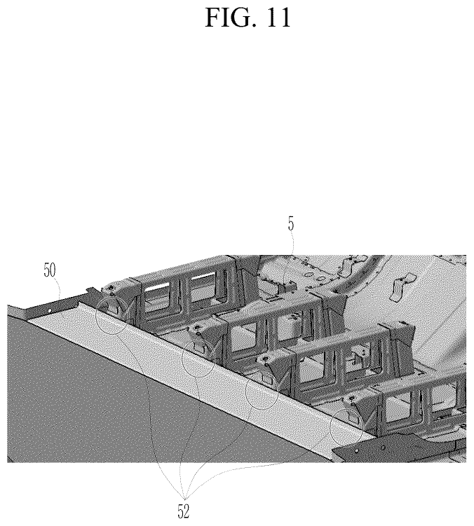

FIG. 10 is a diagram showing a center flattening panel and a front flattening panel installed on the ramp module member of the vehicle according to an embodiment of the present disclosure. FIG. 11 is an enlarged view showing the fixing state of the front flattening panel of FIG. 10.

Referring to FIG. 10, the ramp module member of the vehicle according to an embodiment of the present disclosure may further include a front flattening panel 50 covering the center floor front member 6.

The front flattening panel 50 may be made of aluminum (Al) plate.

The front flattening panel 50 may be mounted by being coupled by a bolt to the center floor front member 6, and as shown in FIG. 11, fixed to a rear surface of a first row seat member of the vehicle body 5 and to the center floor front member 6 by a bolt 52.

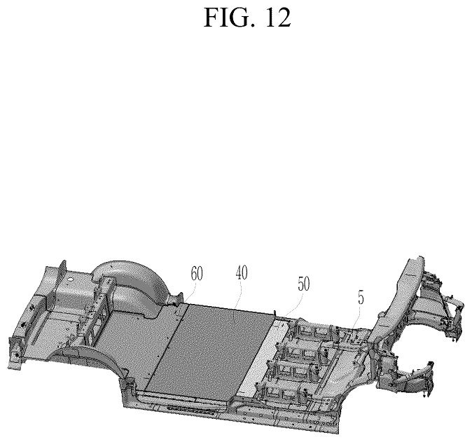

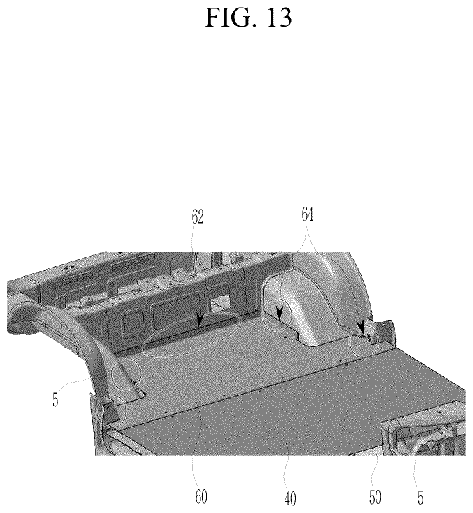

FIG. 12 is a diagram showing a center flattening panel, a front flattening panel, and a rear flattening panel installed on the ramp module member of the vehicle according to an embodiment of the present disclosure. FIG. 13 is an enlarged view showing the fixing state of the rear flattening panel of FIG. 12.

Referring to FIG. 12, the ramp module member of the vehicle according to an embodiment of the present disclosure may further include a rear flattening panel 60 covering the rear floor front member 8.

The rear flattening panel 60 may be made of aluminum (Al) plate.

The rear flattening panel 60 may be mounted by being coupled by bolts to the rear floor front member 8, and as shown in FIG. 12, fixed to a front surface and a wheel side of a third row seat member of the vehicle body 5 and to the rear floor front member 8 by bolts 62 and 64.

The center flattening panel 40, the front flattening panel 50, and the rear flattening panel 60 may be installed at the same height such that no step is formed at boundary parts.

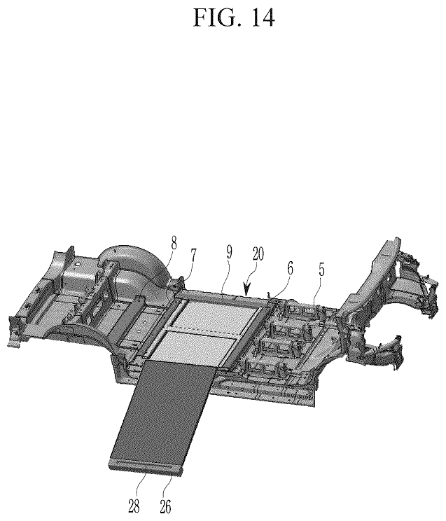

FIG. 14 is a diagram showing the use state of a ramp of the ramp module member of the vehicle according to an embodiment of the present disclosure.

Referring to FIG. 14, a ramp reinforcement member 26 used to withdraw the ramp 22 to the outside of the center in-floor ramp module 20 and supported on the ground after withdrawing may be further provided on an end of the ramp 22 on the opposite side of the center floor side member 9. That is, the ramp reinforcement member 26 may serve as a handle for a user to withdraw the ramp 22 and may have sufficient rigidity to be supported on the ground after the ramp 22 is withdrawn.

In addition, the ramp reinforcement member 26 may improve the rigidity of the vehicle body 5 in a ramp entrance (mounting) state. That is, the ramp reinforcing member 26 may serve as a lateral collision reinforcement member in the entrance state.

When the ramp reinforcement member 26 is withdrawn, an upper surface of the ramp reinforcement member 26 may be configured to match an upper surface of the ramp 22 to prevent a step from being formed.

A groove 28 in the form of a furrow extending in a longitudinal direction of the ramp reinforcement member 26 may be formed in the ramp reinforcement member 26. The groove 28 may be formed to a predetermined depth such that the user may withdraw or push and insert the ramp 22 by using his or her hand or a tool.

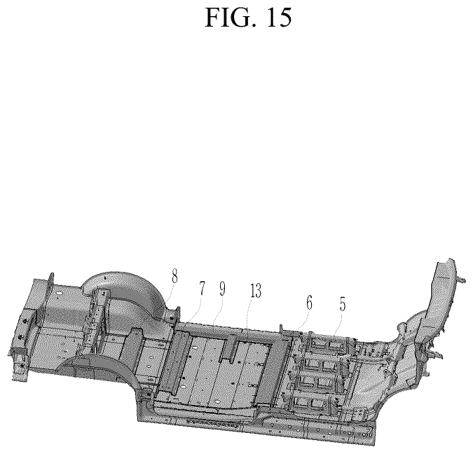

FIG. 15 is a diagram showing a dummy reinforcement center floor side member further provided on a lower radial vehicle body member of the vehicle according to an embodiment of the present disclosure.

Referring to FIG. 15, a dummy reinforcement center floor side member 13 extending in the transverse direction of the vehicle body 5 may be further connected to and installed in a center part of the center floor side member 9. The dummy reinforcement center floor side member 13 serves to additionally reinforce the strength of the vehicle body 5 when supporting an additional load or supporting a load in a larger vehicle model.

The dummy reinforcement center floor side members 13 may be configured in plural at appropriate positions as needed. One end of the dummy reinforcement center floor side member 13 may be welded to a side part of the center floor side member 9, and a lower portion thereof may be welded to a bottom surface of the vehicle body 5.

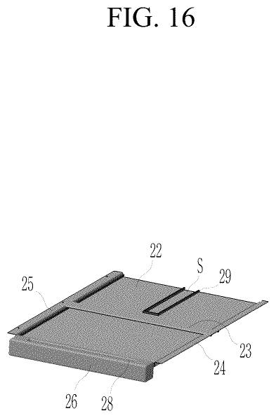

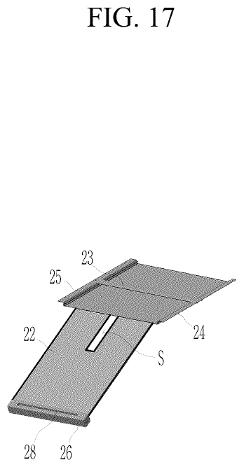

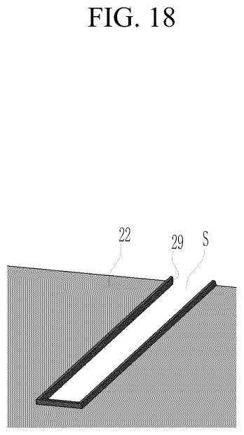

FIG. 16 is a diagram showing a ramp reinforcement member, a ramp slit opening, and a step portion further provided on a ramp of the ramp module of the vehicle according to an embodiment of the present disclosure. FIG. 17 is a diagram showing the use state of the ramp of FIG. 16. FIG. 18 is an enlarged view of the ramp of FIG. 16.

Referring to FIGS. 16 and 17, a ramp slit opening S into which the dummy reinforcement center floor side member 13 is inserted and mounted may be further provided in the ramp 22. That is, the ramp 22 may be provided to be slidable on the plurality of ramp module members 23, 24, and 25 by further including the ramp slit opening S so as to correspond to the shape of a bottom surface of the vehicle body 5 formed by the center floor front member 6, the center floor rear member 7, the center floor side member 9, and the dummy reinforcement center floor side member 13.

Meanwhile, as shown in FIG. 18, a step portion 29 protruding upward from the ramp 22 may be formed on an outer circumference of the ramp slit opening S. The step portion 29 may prevent wheels of a ride used by a passenger from falling through the ramp slit opening S and serve to reinforce the strength of the ramp 22.

Meanwhile, after the ramp 22 is withdrawn from the plurality of ramp module members 23, 24, and 25, a separation prevention protrusion (not shown) and a coupling groove (not shown) may be provided on and in the edge of the ramp 22 opposite to the ramp reinforcement member 26 to prevent the ramp 22 from separating to the outside.

As described above, according to an embodiment of the present disclosure, by employing a structure in which the in-floor ramp module for people with mobility impairments is mounted to the lower radial vehicle body member, it is possible to respond to a PBV market of various specifications, by maximizing common use without changing the existing vehicle model.

In addition, by installing the flattening panel and employing the ramp device that is accommodated in a lower portion thereof and slides through the side door of the vehicle, the appearance may be beautiful and loading and usability may be improved.

Although preferred embodiments of the present disclosure have been described above, the present disclosure is not limited to the above embodiments, and the present disclosure includes all modifications within the range easily changed and recognized as being equivalent by those of ordinary skill in the art to which the present disclosure pertains from the embodiments of the present disclosure.

The following reference identifiers may be used in connection with the drawings to describe various features of embodiments of the present invention.
5: vehicle body
6: center floor front member
7: center floor rear member
8: rear floor front member
9: center floor side member
12: side sill
13: dummy reinforcement center floor side member
14: anchor mounting member
15: ride fixing device
20: center in-floor ramp module
22: ramp
23: center ramp module member
24: front ramp module member
25: rear ramp module member
26: ramp reinforcement member
28: groove
29: step portion
40: center flattening panel
50: front flattening panel
60: rear flattening panel
52, 62, 64: bolt
S: ramp slit opening

What is claimed is:

1. A ramp module of a vehicle disposed on a vehicle body inside the vehicle, the ramp module comprising:
a center floor front member and a center floor rear member disposed at a center portion of a lower portion of the vehicle body in a transverse direction of the vehicle body;
a center floor side member disposed in a longitudinal direction of the vehicle body and connecting the center floor front member and the center floor rear member at one side of the vehicle body; and
a center in-floor ramp module covering the center floor front member, the center floor rear member, and the center floor side member, the center in-floor ramp module being slidably movable in the transverse direction of the vehicle body.

2. The ramp module of claim 1, wherein a lower part of the center floor side member is connected to a side sill of the vehicle body with the vehicle body therebetween.

3. The ramp module of claim 1, further comprising a rear floor front member disposed in a rear portion of the lower portion of the vehicle body in the transverse direction of the vehicle body.

4. The ramp module of claim 3, wherein an anchor mounting member is disposed in the center floor front member and the rear floor front member, the anchor mounting member being configured to fix a ride inside the vehicle.

5. The ramp module of claim 3, wherein the center in-floor ramp module comprises:
a plurality of ramp module members fixed to the center floor front member, the center floor rear member, and the center floor side member; and
a ramp configured to slidably move in the transverse direction of the vehicle body between the ramp module members.

6. The ramp module of claim 5, wherein the ramp module members comprise:
a front ramp module member and a rear ramp module member disposed in the transverse direction of the vehicle body; and
a center ramp module member disposed in the longitudinal direction of the vehicle body and connecting center parts of the front ramp module member and the rear ramp module member.

7. The ramp module of claim 6, wherein the front ramp module member and the rear ramp module member partially overlap on and are coupled by bolts onto the center floor front member and the center floor rear member.

8. The ramp module of claim 7, wherein the ramp is disposed to be slidable between a floor part defined by a space between the front ramp module member and the rear ramp module member and a lower portion of the center ramp module member.

9. The ramp module of claim 5, further comprising:
a center flattening panel covering the ramp module members, the ramp, and the center floor side member;
a front flattening panel covering the center floor front member; and
a rear flattening panel covering the rear floor front member.

10. The ramp module of claim 9, wherein the center flattening panel, the front flattening panel, and the rear flattening panel comprise aluminum plates.

11. The ramp module of claim 9, wherein the front flattening panel is fixed to a rear surface of a first row seat member of the vehicle body and to the center floor front member by a bolt.

12. The ramp module of claim 9, wherein the rear flattening panel is fixed to a front surface and a wheel side of a third row seat member of the vehicle body and to the rear floor front member by bolts.

13. The ramp module of claim 5, further comprising a ramp reinforcement member disposed on an end of the ramp opposite the center floor side member, wherein the ramp reinforcement member is configured to withdraw the ramp to an outside of the center in-floor ramp module and support the ramp on a ground surface after withdrawing.

14. The ramp module of claim 13, further comprising a groove disposed in the ramp reinforcement member and extending in a longitudinal direction of the ramp reinforcement member.

15. A ramp module of a vehicle disposed on a vehicle body inside the vehicle, the ramp module comprising:
a center floor front member and a center floor rear member disposed at a center portion of a lower portion of the vehicle body in a transverse direction of the vehicle body;
a center floor side member disposed in a longitudinal direction of the vehicle body and connecting the center floor front member and the center floor rear member at one side of the vehicle body;
a center in-floor ramp module covering the center floor front member, the center floor rear member, and the center floor side member, the center in-floor ramp module being slidably movable in the transverse direction of the vehicle body, and the center in-floor ramp module comprising:
a plurality of ramp module members fixed to the center floor front member, the center floor rear member, and the center floor side member; and
a ramp configured to slidably move in the transverse direction of the vehicle body between the ramp module members;
a rear floor front member disposed in a rear portion of the lower portion of the vehicle body in the transverse direction of the vehicle body; and
a dummy reinforcement center floor side member disposed in a center part of the center floor side member and extending in the transverse direction of the vehicle body.

16. The ramp module of claim 15, further comprising a ramp slit opening disposed in the ramp, wherein the dummy reinforcement center floor side member is inserted and mounted in the ramp slit opening.

17. The ramp module of claim 16, further comprising a step portion protruding upward from the ramp on an outer circumference of the ramp slit opening.

18. A vehicle comprising:
a vehicle body;
a ramp module disposed on the vehicle body, the ramp module comprising:
a center floor front member and a center floor rear member disposed at a center portion of a lower portion of the vehicle body in a transverse direction of the vehicle body;
a center floor side member disposed in a longitudinal direction of the vehicle body and connecting the center floor front member and the center floor rear member at one side of the vehicle body;
a center in-floor ramp module covering the center floor front member, the center floor rear member, and the center floor side member, wherein the center in-floor ramp module is slidably movable in the transverse direction of the vehicle body, and wherein the center in-floor ramp module comprises:
a plurality of ramp module members fixed to the center floor front member, the center floor rear member, and the center floor side member, the ramp module members comprising a front ramp module member and a rear ramp module member disposed in the transverse direction of the vehicle body and a center ramp module member disposed in the longitudinal direction of the vehicle body and connecting center parts of the front ramp module member and the rear ramp module member; and
a ramp configured to slidably move in the transverse direction of the vehicle body between the ramp module members;
a rear floor front member disposed in a rear portion of the lower portion of the vehicle body in the transverse direction of the vehicle body;
a center flattening panel covering the ramp module member, the ramp, and the center floor side member;
a front flattening panel covering the center floor front member; and
a rear flattening panel covering the rear floor front member.

19. The vehicle of claim 18, wherein the ramp module further comprises a ramp reinforcement member disposed on an end of the ramp opposite the center floor side member, wherein the ramp reinforcement member is configured to withdraw the ramp to an outside of the center in-floor ramp module and support the ramp on a ground surface after withdrawing.

20. The vehicle of claim 19, further comprising a groove disposed in the ramp reinforcement member and extending in a longitudinal direction of the ramp reinforcement member.
